(19) United States
(12) Patent Application Publication
(10) Pub. No.: US 2020/0158305 A1
(43) Pub. Date: May 21, 2020

(54) LIGHT GUIDE-BASED HIGH-LOW BEAM SYSTEM AND VEHICLE LAMP

(71) Applicant: HASCO VISION TECHNOLOGY CO., LTD., Jia Ding, Shanghai (CN)

(72) Inventor: Zhaoyu Chen, Jia Ding, Shanghai (CN)

(21) Appl. No.: 16/090,386

(22) PCT Filed: May 9, 2018
(86) PCT No.: PCT/CN2018/086100

§ 371 Date: Oct. 1, 2018

(30) Foreign Application Priority Data
Apr. 13, 2018 (CN) 201810331745.4

(51) Int. Cl. F21S 41/24; F21S 41/275

(52) U.S. Cl. CPC F21S 41/24; F21W 2102/145; F21S 41/275

(57) ABSTRACT

A light guide-based high-low beam system and a vehicle lamp are provided, relating to the technical field of vehicle-lamp illumination system. The high-low beam system includes a collimating light-transmitting device and a light guide. The collimating light-transmitting device and the light guide are disposed in sequence in the direction in which beams are emitted from the light source. The light-exiting face of the light guide is a convex face so that the beams emitted from the at least one light source exit through the collimating light-transmitting device and the light guide successively, forming a light spot with parallel upper and lower beams and diffusive left and right beams. In the present solution, different light sources are combined to produce one of a low-beam broadening light pattern, a low-beam inflecting light pattern and a high-beam light pattern, and various functions such as AFS and ADB can be realized.

### CROSS REFERENCE TO RELATED APPLICATIONS

The present disclosure claims the priority to the Chinese Patent Application No. 2018103317454, entitled “Light Guide-Based High-low Beam System and Vehicle Lamp” and filed with SIPO on Apr. 13, 2018, the entire content of which is incorporated herein by reference.

### TECHNICAL FIELD

The present disclosure relates to the technical field of vehicle lamp illumination system, and particularly to a high-low beam system based on a light guide (light guide-based high-low beam system) and a vehicle lamp.

### BACKGROUND ART

At present, there are mainly two ways of producing high/low beams in the current automobile lamp illumination optical system, i.e. by lens and by reflection, which lack diversity.

### SUMMARY

It is an object of the present disclosure to provide a high-low (far-near) beam system based on a light guide which realizes various functions, e.g. low beam, high beam, AFS and ADB, and solves the technical problem of lacking diversity in the prior art.

It is another object of the present disclosure to provide a vehicle lamp having the above high-low beam system based on a light guide.

To achieve at least one of the above objects, the embodiments of the present disclosure provide the following technical solutions.

The first aspect of the present disclosure provides a high-low beam system based on a light guide, which includes a collimating light-transmitting devices and a light guide.

The collimating light-transmitting device and the light guide are disposed in sequence in the direction in which beams (light beams) are emitted from light source(s). The light-exiting face of the light guide is a convex face, so that the beams emitted from the at least one light source exit through the collimating light-transmitting device and the light guide successively, forming a light spot with parallel upper and lower beams and diffusive left and right beams. Different light sources are combined to produce one of a low-beam broadening light pattern, a low-beam inflecting light pattern and a high-beam light pattern.

Optionally, the light-exiting portion of the collimating light-transmitting device is located on the focal plane of a lens formed by the light guide on its cross-section.

Optionally, the diameter of a light path of the collimating light-transmitting device increases gradually at first and then decreases gradually.

Optionally, the collimating light-transmitting device includes a light-entering segment which gradually enlarges in a direction from its light-entering face to its light-exiting face and a light-exiting segment which gradually tapers in a direction from the light-entering segment to the light-exiting face.

Optionally, the light-entering segment has a shorter extension length than the light-exiting segment, and the light-entering segment has a larger taper degree than the light-exiting segment.

Optionally, the light-entering face of the light guide is any one of a flat face, a concave face and a convex face.

Optionally, the collimating light-transmitting device and the light guide are combined such that when multiple light sources arranged along an arc line emit beams to the collimating light-transmitting device, the upper end of a light spot of a light pattern formed of the beams passing through the light-exiting face of the light guide is located at the left cut-off line of a low beam in a national standard.

Optionally, the light pattern may be used as the broadening part of a low-beam light pattern.

Optionally, the height of the light-exiting portion of the collimating light-transmitting device in the case that the light spot is of a low-beam inflecting light pattern is smaller than the height of the light-exiting portion of the collimating light-transmitting device in the case that the light spot is of a low-beam broadening light pattern. The upper end of the light spot formed by a single light source reaches the right cut-off line of the low-beam light pattern and forms an inflection point.

Optionally, the collimating light-transmitting device is configured to be vertically movable with respect to the light guide, so as to adjust the height of the light-exiting portion of the collimating light-transmitting device relative to the light guide.

Optionally, the opening of the light-exiting portion of the collimating light-transmitting device is configured to have an adjustable size, and the collimating light-transmitting device is configured to be vertically movable with respect to the light guide, so as to adjust the height of the light-exiting portion of the collimating light-transmitting device relative to the light guide, so that a high-beam light pattern can be formed by adjusting the size of the opening of the light-exiting portion of the collimating light-transmitting device and/or its position in an up-down direction of the light guide.

Optionally, the preset light source for forming a high-beam light spot is configured to be controlled to be turned on or off, so that an anti-glare function may be realized by turning off the preset light source for forming a high-beam light spot.

Optionally, the collimating light-transmitting device is integrally formed with the light guide.

Optionally, the collimating light-transmitting device is any one of a collimating lens, a light condenser, a convex lens and a Fresnel lens.

Optionally, the light-entering face of the light guide is a flat face and is parallel with the focal plane.

Optionally, the collimating light-transmitting device and the light guide are separately disposed. The light guide is in an arc-shaped structure formed by a closed section extending along an arc-shaped guide line, and the said section is formed by combination of a first side line and a second side line. The first side line is a straight line, and the second side line is an arc-shaped line that protrudes outwards. The first side line moves in the extension direction of the arc-shaped guide line to form the light-entering face of the said light guide. The second side line moves in the extension direction of the arc-shaped guide line to form the light-exiting face of the said light guide. The arc-shaped guide line is an arc-shaped curve that protrudes outwards in the direction in which the second side line protrudes. The light-exiting portion of the collimating light-transmitting device is opposite to the light-entering face of the light guide.

Optionally, the collimating light-transmitting device is integrally formed with the light guide. The side of the light guide that is away from its light-exiting face is integrally connected onto the light-exiting face of the collimating light-transmitting device, so that the light guide and the collimating light-transmitting device form an integrated structure.

Optionally, the light-exiting face of the light guide is a convex arc face formed by a convex curve extending along an arc-shaped guide line. The light guide is limited between the light-exiting face of the collimating light-transmitting device and the light-exiting face of the light guide, to form a structure with an approximately sectorial section.

Optionally, the height-direction dimension of the light-exiting face of the collimating light-transmitting device is smaller than the height-direction dimension of the light-exiting face of the light guide, such that the light guide forms a structure with an approximately sectorial section, in which the side of the light guide that is close to the collimating light-transmitting device has a relatively-small height-direction dimension and the side of the light guide that is away from the collimating light-transmitting device has a relatively-large height-direction dimension.

Another aspect of the present disclosure provides a vehicle lamp which includes a light source and the high-low beam system based on a light guide described above. The light source is provided to be corresponding to the collimating light-transmitting device. There are multiple light sources. The multiple light sources are arranged in sequence in the extension direction of the light guide and are located at the side of the said light guide where the light-entering face is located.

With the above technical solutions, the present disclosure provides the following beneficial effects.

In the high-low beam system based on a light guide provided by the embodiments of the present disclosure, the collimating light-transmitting device and the light guide are disposed in sequence in the direction in which beams are emitted from the light source. The light-exiting face of the light guide is a convex face, so that the beams emitted from at least one light source exit through the collimating light-transmitting device and the light guide successively, forming a light spot with parallel upper and lower beams and diffusive left and right beams. Different light sources are combined produce one of a low-beam broadening light pattern, a low-beam inflecting light pattern and a high-beam light pattern, and it can realize various functions such as AFS and ADB.

It should be noted that AFS is the abbreviation for Adaptive Front Lighting System. Adaptive Driving Beam (ADB for short) is a smart anti-glare high-beam system. LED-ADB refers to a smart anti-glare high-beam system composed of LEDs (light emitting diodes) and having ADB function. By sensing the presence of other vehicles running ahead of a vehicle by a camera, the LED-ADB system performs real-time calculation and controls the corresponding LED particles in the high-beam group to be dimmed or turned off in real time to avoid causing glare to the vehicles ahead. It ensures the driving safety while ensuring a best view.

### BRIEF DESCRIPTION OF DRAWINGS

In order to more clearly explain the technical solutions in the embodiments of the present disclosure or in the prior art, figures to be used in the detailed description of embodiments or in the description of the prior art will be briefly described. Obviously, the figures in the following description merely show some of the embodiments of the present disclosure. Other figures may be obtained by those ordinarily skilled in the art based on these figures without paying creative efforts.

FIG. 1 is a schematic structural diagram of a high-low beam system based on a light guide provided by embodiments of the present disclosure.

FIG. 2 is a schematic cross-sectional principle structural diagram of a high-low beam system based on a light guide according to an implementation provided by embodiments of the present disclosure.

FIG. 3 is a schematic cross-sectional principle structural diagram of a high-low beam system based on a light guide according to another implementation provided by embodiments of the present disclosure.

FIG. 4 is a schematic diagram of a light spot formed by a single light source of a high-low beam system based on a light guide provided by the present disclosure.

FIG. 5 is a schematic diagram of a light spot formed by multiple light sources of a high-low beam system based on a light guide provided by the present disclosure.

FIG. 6 is a schematic diagram of a light spot for bending function formed by multiple light sources of a high-low beam system based on a light guide provided by the present disclosure.

FIG. 7 is a schematic cross-sectional principle structural diagram of a high-low beam system based on a light guide according to a further implementation provided by embodiments of the present disclosure.

FIG. 8 is a schematic diagram of a light spot of a portion of a single inflection point, with the light spot formed by multiple light sources of a high-low beam system based on a light guide provided by the present disclosure.

FIG. 9 is a schematic diagram of a light spot of a portion of multiple inflection points, with the light spots formed by multiple light sources of a high-low beam system based on a light guide provided by the present disclosure.

FIG. 10 is a schematic diagram of a light spot of a portion of an inflection point for right turn bend illumination, with the light spot formed by multiple light sources of a high-low beam system based on a light guide provided by the present disclosure.

FIG. 11 is a schematic diagram of a light spot of a portion of an inflection point for left turn bend illumination, with the light spot formed by multiple light sources of a high-low beam system based on a light guide provided by the present disclosure.

FIG. 12 is a schematic diagram of a high-beam light spot formed by a single light source of a high-low beam system based on a light guide provided by the present disclosure.

FIG. 13 is a schematic diagram of a high-beam light spot formed by multiple light sources of a high-low beam system based on a light guide provided by the present disclosure.

FIG. 14 is a schematic diagram of a high-low beam system based on a light guide provided by the present disclosure, with some light sources turned off for realizing the ADB function.

Reference signs: 1—light source, 2—collimating lens, 21—light-entering segment, 22—light-exiting segment, 3—light guide, 4—beam, 5—focal plane, 6—light-exiting portion, 7—light spot, 8—low-beam light pattern, 9—high-beam light spot, 10—dark zone, L0—arc-shaped guide line, L1—second side line, L2—first side line.

### DETAILED DESCRIPTION OF EMBODIMENTS

The technical solutions of the present disclosure will be clearly and completely described with reference to the figures. Apparently, the embodiments described are merely some but not all of the embodiments of the present disclosure. All the other embodiments obtained by those ordinarily skilled in the art based on the embodiments provided in the present disclosure without using creative efforts shall fall within the scope of protection of the present disclosure. It should be noted that the embodiments of the present invention and the features in the embodiments can be combined without conflict.

It is to be noted that in the description of the present disclosure, orientational or positional relations indicated by terms such as “center”, “upper”, “lower”, “left”, “right”, “vertical”, “horizontal”, “inner” and “outer” are the orientational or positional relations shown based on the figures, only for facilitating and simplifying description of the present disclosure, rather than indicating or implying that the referred devices or elements must be in a particular orientation or constructed or operated in the particular orientation, and therefore they should not be construed as limiting the present disclosure. In addition, terms like “first”, “second” and “third” are merely used for descriptive purpose, but should not be construed as indicating or implying importance in relativity.

It should also be noted that in the present disclosure, terms like “mount”, “coupled” and “connected” should be interpreted in a broad sense, unless otherwise explicitly specified and defined. For example, a connection could be fixed connection, detachable connection, or integrated connection, or it could be mechanical connection or electrical connection, or it could be direct connection or indirect connection via an intermediate medium, or it could be internal communication between two elements. Those ordinarily skilled in the art can understand the specific meanings of the above terms in the present disclosure according to specific circumstances.

Now, the present disclosure will be further explained with reference to specific embodiments.

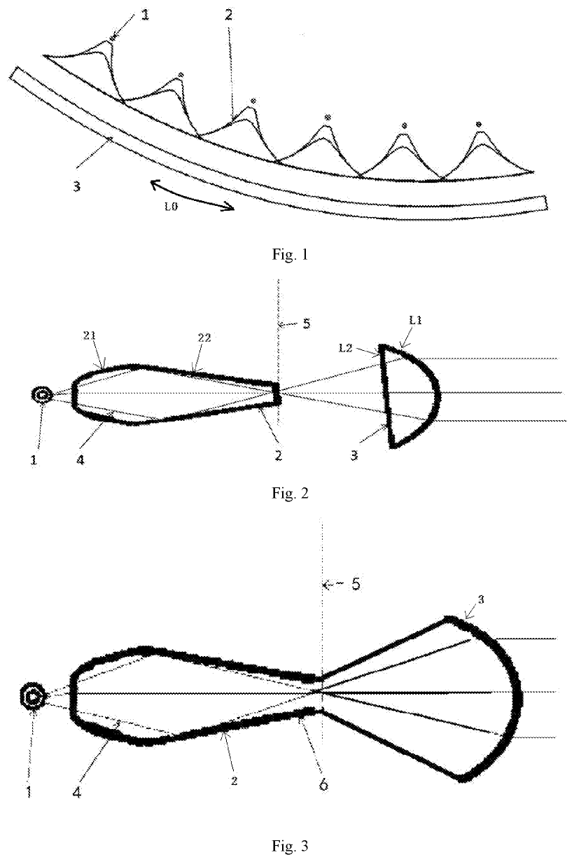

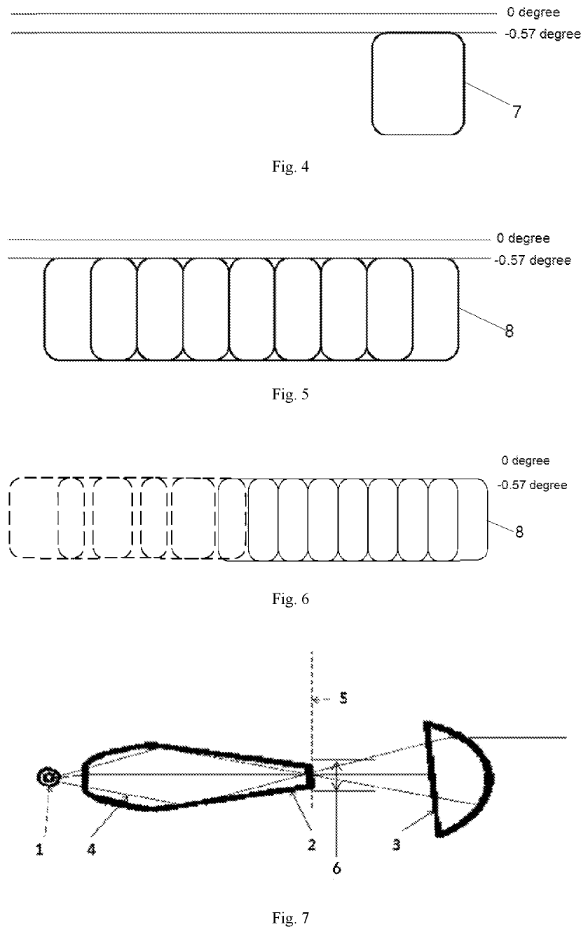

FIG. 1 is a schematic structural diagram of a high-low beam system based on a light guide provided by embodiments of the present disclosure. FIG. 2 is a schematic cross-sectional principle structural diagram of a high-low beam system based on a light guide according to an implementation provided by embodiments of the present disclosure. FIG. 3 is a schematic cross-sectional principle structural diagram of the high-low beam system based on a light guide according to another implementation provided by embodiments of the present disclosure. FIG. 4 is a schematic diagram of a light spot formed by a single light source of the high-low beam system based on a light guide provided by the present disclosure.

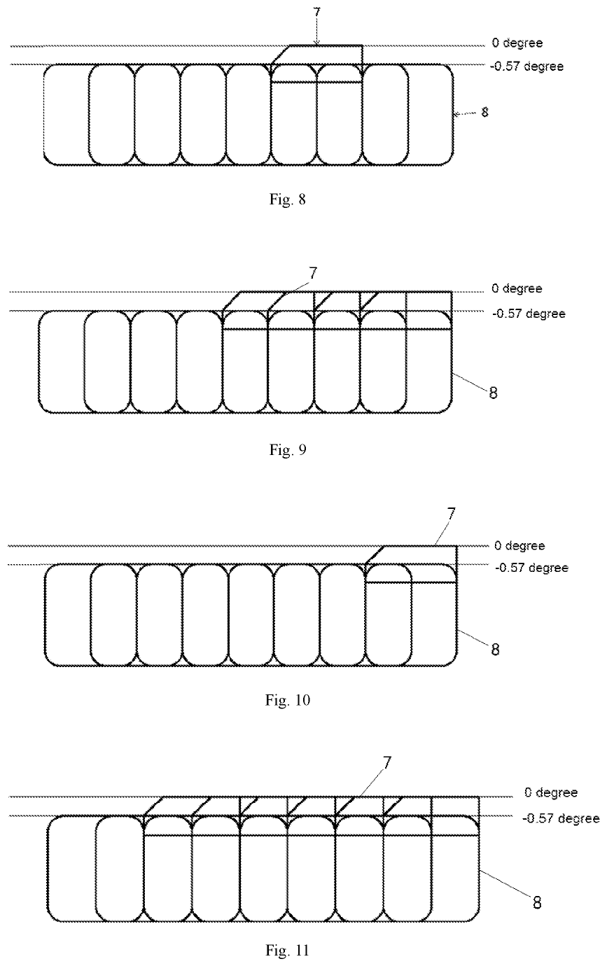

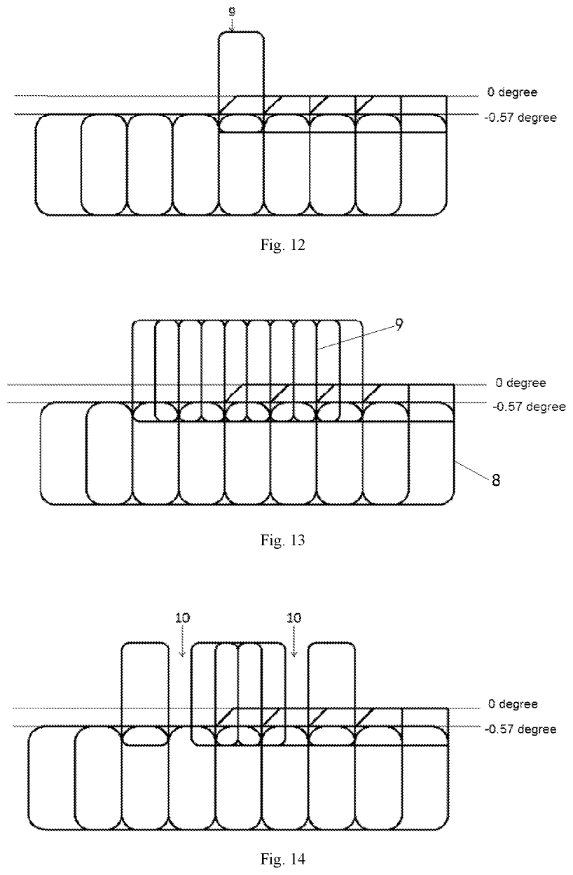

FIG. 5 is a schematic diagram of a light spot formed by multiple light sources of the high-low beam system based on a light guide provided by the present disclosure. FIG. 6 is a schematic diagram of the light spot for bending function formed by multiple light sources of the high-low beam system based on a light guide provided by the present disclosure. FIG. 7 is a schematic cross-sectional principle structural diagram of the high-low beam system based on a light guide according to a further implementation provided by embodiments of the present disclosure. FIG. 8 is a schematic diagram of a light spot of a portion of a single inflection point, with the light spot formed by multiple light sources of the high-low beam system based on a light guide provided by the present disclosure. FIG. 9 is a schematic diagram of a light spot of a portion of multiple inflection points, with the light spots formed by multiple light sources of the high-low beam system based on a light guide provided by the present disclosure. FIG. 10 is a schematic diagram of a light spot of a portion of an inflection point for right turn bend illumination, with the light spot formed by multiple light sources of the high-low beam system based on a light guide provided by the present disclosure; FIG. 11 is a schematic diagram of a light spot of a portion of an inflection point for left turn bend illumination, with the light spot formed by multiple light sources of the high-low beam system based on a light guide provided by the present disclosure. FIG. 12 is a schematic diagram of a high-beam light spot formed by a single light source of the high-low beam system based on a light guide provided by the present disclosure. FIG. 13 is a schematic diagram of a high-beam light spot formed by multiple light sources of the high-low beam system based on a light guide provided by the present disclosure. FIG. 14 is a schematic diagram of the high-low beam system based on a light guide provided by the present disclosure, with some light sources turned off for realizing the ADB function.

### Embodiment 1

As shown in FIG. 1 to FIG. 14, the high-low beam system based on a light guide provided by the present example includes a collimating light-transmitting device and a light guide 3.

Specifically, as shown in FIG. 1 to FIG. 3, the collimating light-transmitting device and the light guide 3 are provided in sequence in the direction in which the beams 4 are emitted from the light sources 1. The light-exiting face of the light guide 3 is a convex face, so that the beams 4 emitted from at least one light source 1 exit through the collimating light-transmitting device and the light guide 3 successively, forming a light spot 7 with parallel upper and lower beams 4 and diffusive left and right beams 4. Different light sources 1 are combined to produce one of a low-beam broadening light pattern (the light spot of the light pattern formed of the multiple light sources is located at the left cut-off line of a low beam in the national standard), a low-beam inflecting light pattern (the light spot of the light pattern formed of the multiple light sources comprises a light spot located at the left cut-off line of a low beam in the national standard and a light spot which reaches the right cut-off line of a low-beam in the national standard and forms an inflection point) and a high-beam light pattern.

On the basis of the above example, as shown in FIG. 2 to FIG. 3, the light-exiting portion 6 of the collimating light-transmitting device is located on the focal plane 5 of the lens formed by the light guide 3 on its cross-section. Optionally, the light-entering face of the light guide 3 is a flat face and is parallel with the focal plane 5.

Optionally, the diameter of a light path of the collimating light-transmitting device increases gradually at first and then decreases gradually.

It should be noted that the light-entering face of the light guide 3 is any one of a flat face, a concave face or a convex face. Additionally, the collimating light-transmitting device may be a collimating lens 2 or a light condenser, or a convex lens or a Fresnel or other light-transmitting devices having a collimation function.

As an optional embodiment, a collimating lens 2 is chosen to be used as the collimating light-transmitting device. The beams 4 emitted from the light sources 1 pass through the light guide 3 after being collimated by the collimating lens 2, wherein the light-exiting portion 6 of the collimating light-transmitting device located on the focal plane 5 of the lens formed by the light guide 3 on its cross-section, which forms a light spot 7 with approximately parallel upper and lower beams 4 and diffusive left and right beams 4.

In the present example, the collimating lens 2 and the light guide 3 may be provided as parts independent of each other, and may be connected indirectly, or they may form a compound lens, that is, the collimating lens 2 and the light guide 3 are integrally molded to form an independent part.

FIG. 2 shows a form that the collimating lens 2 and the light guide 3 are provided as parts independent of each other. Referring to FIG. 2, the collimating light-transmitting device 2 and the light guide 3 are provided to be separated from each other. The light guide 3 is in an arc-shaped structure formed by a closed section extending along an arc-shaped guide line L0 (in combination with FIG. 1) and the section is formed by combination of a first side line L2 and a second side line L1. The first side line is a straight line, and the second side line L1 is the arc-shaped line that protrudes outwards. The first side line L2 moves in the extension direction of the arc-shaped guide line L0 to form the light-entering face of the light guide 3. The second side line L1 moves in the extension direction of the arc-shaped guide line L0 to form the light-exiting face of the light guide 3. The arc-shaped guide line L0 is an arc-shaped curve that protrudes outwards in the direction that the second side line L1 protrudes. The light-exiting portion of the collimating light-transmitting device 2 is opposite to the light-entering face of the light guide 3. Optionally, the collimating light-transmitting device 2 includes a light-entering segment 21 which gradually enlarges in a direction from its light-entering face to its light-exiting face and a light-exiting segment 22 which gradually tapers in a direction from the light-entering segment 21 to the light-exiting face. Optionally, the light-entering segment 21 has a shorter extension length than the light-exiting segment 22 and the light-entering segment 21 has a larger taper degree than the light-exiting segment 22, so as to better allow the beams to pass therethrough to form a suitable light spot.

In an optional embodiment, the collimating light-transmitting device 2 is configured to be vertically movable with respect to the light guide 3, so as to adjust the height of the light-exiting portion of the collimating light-transmitting device 2 relative to the light guide 3. For example, in a vehicle lamp structure, the light guide 3 is fixedly disposed and the collimating light-transmitting device 2 is provided to be movable in a controllable manner, or the collimating light-transmitting device 2 is fixedly disposed and the light guide 3 is provided to be movable in a controllable manner. Optionally, the opening of the light-exiting portion of the collimating light-transmitting device 2 is configured to have an adjustable size, and the collimating light-transmitting device 2 is configured to be vertically movable with respect to the light guide 3, so as to adjust the height of the light-exiting portion of the collimating light-transmitting device 2 relative to the light guide 3, so that a high-beam light pattern can be formed by adjusting the size of the opening of the light-exiting portion of the collimating light-transmitting device 2 and/or its position in the up-down direction of the light guide 3.

Referring to FIG. 3, the collimating light-transmitting device 2 is integrally formed with the light guide 3. The side of the light guide 3 that is away from its light-exiting face is integrally connected onto the light-exiting face of the collimating light-transmitting device 2, so that the light guide 3 and the collimating light-transmitting device 2 form an integrated structure. The light-exiting face of the light guide 3 is a convex arc face formed by a convex curve extending along an arc-shaped guide line L0. The light guide 3 is limited between the light-exiting face of the collimating light-transmitting device 2 and the light-exiting face of the light guide 3 to form a structure with an approximately sectorial section. Optionally, the light-exiting face of the collimating light-transmitting device 2 has a smaller height-direction dimension than the light-exiting face of the light guide 3, so that the light guide 3 forms a structure with an approximately sectorial section, wherein the side of the light guide that is close to the collimating light-transmitting device 2 has a smaller height-direction dimension and the side of the light guide that is away from the collimating light-transmitting device 2 has a larger height-direction dimension.

In the present example, the preset light source for forming a high-beam light spot may be configured to be controlled to be turned on or off, so that the anti-glare function may be realized by turning off the preset light source for forming a high-beam light spot.

As shown in FIG. 4, the light spot 7 is formed by a single light source 1. As shown in FIG. 5, when multiple light sources 1 arranged along an arc line emit beams to the collimating light-transmitting device, the upper end of the light spot 7 of the light pattern formed of the beams through the light-exiting face of the light guide 3 is located at the left cut-off line of a low beam in the national standard, namely, the upper end of the light sport 7 is located at −0.57 which is the left cut-off line of the low beam in the national standard. This light pattern may be used as the broadening part of low-beam light pattern 8, and may also be individually used as class V low beam in GB/T30036 or ECE R123.

Optionally, the light pattern may be used as the broadening part of low-beam light pattern. In addition, as shown in FIG. 6, by controlling turning on or off of the light source 1 which may be an LED light source, the outside module (the light pattern of which is identical to the light pattern of the low-beam portion, but has a more outward angle than the low-beam light spot) may also be activated by controlling on/off of the LED, realizing the bending function.

In an implementation of the above embodiment, as shown in FIG. 7, the light-exiting portion 6 of the collimating light-transmitting device in the case of low-beam inflecting light pattern has a smaller height than the light-exiting portion 6 of the collimating light-transmitting device in the case of low-beam broadening light pattern, and thus can produce a more concentrated light spot 7.

As shown in FIG. 8, the upper end of the light spot 7 formed by a single light source 1 reaches the low-beam right cut-off line (within an angle range from −0.57 to 1 degree, to be specific) and forms an inflection point.

As shown in FIG. 9, when multiple light sources 1 are turned on at the same time, a complete low-beam light pattern 8 is formed, which satisfies the definition of low beam provided in GB25991 or ECE R112 and also satisfies the requirements of class C and class E low beams provided in GB/T30036 or ECE R123.

When a vehicle is on a bend, as shown in FIG. 10 and FIG. 11, the position of the inflecting point may be shifted by controlling turning on or off of the light sources 1, which achieves a bend illumination effect and thus realizes the function of AFS.

In another optional implementation of the above embodiment, as shown in FIG. 12 and FIG. 13, a high-beam light spot 9 can be formed by adjusting the size of the opening of the light-exiting portion 6 of the collimating light-transmitting device and its position in the up-down direction of the light guide 3.

High-beam light pattern is formed when multiple light sources 1 are turned on at the same time.

In a further optional implementation of the above embodiment, as shown in FIG. 14, the anti-glare function may be realized by turning off the preset light sources for forming a high-beam light spot. That is to say, by turning off some light sources separately, dark zones 10 may be formed to avoid other vehicles and to prevent glare, realizing the ADB function. The positions of the dark zones 10 may be adjusted freely by turning off the light sources based on the position of the vehicle ahead.

### Embodiment 2

Embodiment 2 of the present disclosure provides a vehicle lamp which includes the high-low beam system based on a light guide as described in any of the technical solutions of Embodiment 1 above and the light source. The light source is disposed to be corresponding to the collimating light-transmitting device.

The light source is an LED, may be a light source or a laser light source or may be other suitable light sources.

The vehicle lamp provided by Embodiment 2 of the present disclosure is provided with the high-low beam system based on a light guide provided in Embodiment 1, and thus has all the beneficial effects of the high-low beam system based on a light guide provided in Embodiment 1, which will not be repeated here. There are multiple light sources. The multiple light sources are arranged in sequence in the extension direction of the light guide and are located at the light-entering-face side of the light guide (i.e. the side of the light guide where the light-entering face is located).

Specifically, in an optical system for automobile lamp illumination, there are mainly two ways of producing high beam and light beam, i.e. by lens and by reflection, which lack diversity. However, in the high-low beam system based on a light guide provided by the present disclosure, the collimating light-transmitting device and the light guide are disposed in sequence in the direction in which beams are emitted from the light source. The light-exiting face of the light guide is a convex face, so that the beams emitted from at least one light source exit through the collimating light-transmitting device and the light guide, forming a light spot with parallel upper and lower beams and diffusive left and right beams. Different light sources are combined to produce one of a low-beam broadening light pattern, a low-beam inflecting pattern and a high-beam light pattern. And the high-low beam system based on a light guide realizes various functions e.g. AFS and ADB.

As last, it should be noted that the above embodiments are provided only to explain the technical solutions of the present disclosure, rather than to limit the present disclosure. Although the present disclosure is described in details with reference to the aforementioned embodiments, those ordinarily skilled in the art should understand that they may still make modifications to the technical solutions contained in those embodiments, or make equivalent replacements of some or all of the technical features therein. Such modifications or replacements should not depart from the essence of the respective technical solutions from the scope of the technical solutions in the embodiments of the present disclosure. In addition, those skilled in the art can understand that although some embodiments described herein include some features but not other features included in other embodiments, the combination of features from different embodiments falls within the scope of the present disclosure and produces different embodiments. For example, in the appended claims, any one of the embodiments as claimed can be used in any combinations. The information disclosed in the background art is only intended to enhance the understanding of the overall background art of the present disclosure, but should not be construed as acknowledging or implying in any way that such information constitutes the prior art known to those skilled in the art.

### INDUSTRIAL APPLICABILITY

The high-low beam system based on a light guide and the vehicle lamp of the present disclosure are able to produce one of low-beam broadening light pattern, low-beam inflecting light pattern and high-beam light pattern by the combination of different light sources, and can also realize various functions e.g. AFS and ADB, and thus are applicable to industries.

1. A high-low beam system based on a light guide, comprising:
a collimating light-transmitting device and a light guide, wherein the collimating light-transmitting device and the light guide are provided in sequence in a direction in which beams are emitted from light source(s);
a light-exiting face of the light guide is a convex face so that beams emitted from at least one light source exit through the collimating light-transmitting device and the light guide successively, forming a light spot with parallel upper and lower beams and diffusive left and right beams; and
different light sources are combined to produce one of a low-beam broadening light pattern, a low-beam inflecting light pattern and a high-beam light pattern.

2. The high-low beam system based on a light guide according to claim 1, wherein a light-exiting portion of the collimating light-transmitting device is located on a focal plane of a lens formed by the light guide on a cross-section of the light guide.

3. The high-low beam system based on a light guide according to claim 2, wherein diameter of a light path of the collimating light-transmitting device increases gradually at first and then decreases gradually.

4. The high-low beam system based on a light guide according to claim 1, wherein the collimating light-transmitting device comprises a light-entering segment and a light-exiting segment, with the light-entering segment gradually enlarging in a direction from a light-entering face of the collimating light-transmitting device to a light-exiting face of the collimating light-transmitting device, and the light-exiting segment gradually tapering in a direction from the light-entering segment to the light-exiting face.

5. The high-low beam system based on a light guide according to claim 4, wherein an extension length of the light-entering segment is shorter than an extension length of the light-exiting segment, and a taper degree of the light-entering segment is larger than a taper degree of the light-exiting segment.

6. The high-low beam system based on a light guide according to claim 1, wherein a light-entering face of the light guide is any one of a flat face, a concave face and a convex face.

7. The high-low beam system based on a light guide according to claim 1, wherein the collimating light-transmitting device and the light guide is combined such that when multiple light sources arranged along an arc line emit beams to the collimating light-transmitting device, an upper end of a light spot of a light pattern is located at a left cut-off line of a low beam in a national standard, with the light pattern formed by the beams passing through a light-exiting face of the light guide.

8. The high-low beam system based on a light guide according to claim 7, wherein the light pattern serves as a broadening part of a low-beam light pattern.

9. The high-low beam system based on a light guide according to claim 3, wherein the light-exiting portion of the collimating light-transmitting device, in a case that the light spot is of a low-beam inflecting light pattern, has a smaller height than the light-exiting portion of the collimating light-transmitting device in a case that the light spot is of a low-beam broadening light pattern, and
an upper end of a light spot formed by a single light source reaches a right cut-off line of a low beam to form an inflection point.

10. The high-low beam system based on a light guide according to claim 9, wherein the collimating light-transmitting device is configured to be able to vertically movable with respect to the light guide, so as to adjust a height of the light-exiting portion of the collimating light-transmitting device relative to the light guide.

11. The high-low beam system based on a light guide according to claim 9, wherein an opening of the light-exiting portion of the collimating light-transmitting device is provided to have an adjustable size, and the collimating light-transmitting device is configured to be able to vertically movable with respect to the light guide, so as to adjust a height of the light-exiting portion of the collimating light-transmitting device relative to the light guide, so that a high-beam light pattern is formed by adjusting a size of the opening of the light-exiting portion of the collimating light-transmitting device and/or its position in an up-down direction of the light guide.

12. The high-low beam system based on a light guide according to claim 9, wherein a preset light source configured for forming a high-beam light spot is able to be controlled to be turned on or off, so that an anti-glare function is able to be realized by turning off the preset light source configured for forming a high-beam light spot.

13. The high-low beam system based on a light guide according to claim 1, wherein the collimating light-transmitting device is integrally formed with the light guide.

14. The high-low beam system based on a light guide according to claim 1, wherein the collimating light-transmitting device is any one of a collimating lens, a light condenser, a convex lens and a Fresnel lens.

15. The high-low beam system based on a light guide according to claim 2, wherein a light-entering face of the light guide is a flat face and is parallel with the focal plane.

16. The high-low beam system based on a light guide according to claim 1, wherein the collimating light-transmitting device and the light guide are separately disposed,
the light guide is in an arc-shaped structure formed by a closed section extending along an arc-shaped guide line, and the section is formed by combination of a first side line and a second side line, wherein the first side line is a straight line, and the second side line is an arc-shaped line that protrudes outwards,
the first side line moves in an extension direction of the arc-shaped guide line to form a light-entering face of the light guide, the second side line moves in an extension direction of the arc-shaped guide line to form the light-exiting face of the light guide, the arc-shaped guide line is an arc-shaped curve that protrudes outwards in a direction that the second side line protrudes, and
a light-exiting portion of the collimating light-transmitting device is opposite to the light-entering face of the light guide.

17. The high-low beam system based on a light guide according to claim 4, wherein the collimating light-transmitting device is integrally formed with the light guide,
a side of the light guide that is away from the light-exiting face of the light guide is integrally connected onto the light-exiting face of the collimating light-transmitting device, so that the light guide and the collimating light-transmitting device forms an integrated structure.

18. The high-low beam system based on a light guide according to claim 17, wherein the light-exiting face of the light guide is a convex arc face formed by a convex curve extending along an arc-shaped guide line, the light guide is limited between the light-exiting face of the collimating light-transmitting device and the light-exiting face of the light guide, forming a structure with an approximately sectorial section.

19. The high-low beam system based on a light guide according to claim 18, wherein a height-direction dimension of the light-exiting face of the collimating light-transmitting device is smaller than a height-direction dimension of the light-exiting face of the light guide, such that the light guide forms a structure with an approximately sectorial section, wherein a side of the light guide that is close to the collimating light-transmitting device has a smaller height-direction dimension and a side of the light guide that is away from the collimating light-transmitting device has a larger height-direction dimension.

20. A vehicle lamp, comprising a light source and the high-low beam system based on a light guide according to claim 1, wherein the light source is provided to be corresponding to the collimating light-transmitting device; and the light source comprises multiple light sources, the multiple light sources are arranged in sequence in an extension direction of the light guide and are located at a side of the light guide where the light-entering face is located.
